(19) United States
(12) Patent Application Publication
(10) Pub. No.: US 2005/0241352 A1
(43) Pub. Date: Nov. 3, 2005

(54) Keyway plug for safe deposit locks

(76) Inventors: James Richard Waskiewicz, Livonia, MI (US); Michael Frank Yonkus, Dearborn, MI (US)

Correspondence Address: JAMES R. WASKIEWICZ, 39169 ROSS, LIVONIA, MI, 48154, US

(21) Appl. No.: 11/116,158

(22) Filed: Apr. 27, 2005

Related U.S. Application Data
(60) Provisional application No. 60/565,980, filed on Apr. 28, 2004.

(51) Int. Cl. E05B 47/00; E05B 35/08; E05B 9/04

(52) U.S. Cl. 70/375; 70/276

(57) ABSTRACT

An object of the present invention is to provide a keyway plug for preventing the correct key from opening a safe deposit lock. Another object is to provide a keyway plug that is hidden inside of the lock and out of view from the public. The keyway plug of the present invention provides a means for preventing the correct key from opening the safe deposit lock, while overcoming the deficiencies of the prior art. It includes a plug, an insertion device and an extractor. The plug fits into the keyway to block the entrance of a key. Its tip is similar to the tip of an ordinary safe deposit key. The plug is properly seated in the keyway by an insertion device. Unlike the plug of the prior art it does not protrude from the lock and is not visible from casual inspection. An extractor is used to remove the plug from the keyway. The extractor includes a magnet which is concealed under the head of the device. As the extractor is inserted into the keyway and makes contact with the plug, the plug becomes magnetized. As the extractor is pulled from the keyway the plug is removed leaving unrestricted access to the lock.

### CROSS-REFERENCE TO PROVISIONAL APPLICATION

This application claims the benefit of U.S. patent application Ser. No. 60/565,980, filed 2004 Apr. 27 by the present inventors.

### FEDERALLY SPONSORED RESEARCH

Not applicable

### SEQUENCE LISTING OR PROGRAM

Not applicable

### BACKGROUND OF THE INVENTION

1. Field of Invention

This invention relates to a keyway plug, and an extractor specifically for a self serve safe deposit lock.

2. Background of Invention

This keyway plug and extractor relates to safe deposit locks like that of U.S. Pat. No. 1,431,381, and more specifically to self serve safe deposit locks. Over the past few years financial institutions have been eliminating the Safe Deposit Attendant position. One of the functions of the attendant was to insert the “guard key” in one side of the safe deposit lock and the customer would insert their “customer key” in the other side of the lock. Turning both keys would retract a bolt allowing the lock to open. With the introduction of self serve safe deposit locks the guard side of the lock has been eliminated. The only key required to open this lock is the “customer key”. The customer can now access their safe deposit lock by themselves.

There are occasions when the financial institution has to deny access to the safe deposit lock. Some examples of these denials include; the possibility of someone obtaining the safe deposit key fraudulently, possibly a court order to seal the safe deposit lock, or possibly the rent not being paid, just to name a few.

The safe deposit keyway plug which we invented will solve each of these scenarios by preventing the safe deposit key from fully entering the lock. A keyway plug is inserted into the keyway of the lock and then can be removed with the plug extractor by an employee when the situation has been rectified.

There is a device FIGS. 9 & 10 that has been used to block the keyway. This device can be hard to insert into the lock and can be broken by twisting the padlock thus breaking the device. It also is not aesthetically pleasing and creates unnecessary questions to the management.

### OBJECTS AND ADVANTAGES

Accordingly, several objects and advantages of the safe deposit keyway plug described in our invention are:
(a) the ease of installing and removing the keyway plug;
(b) the visibility of a lock-out device is eliminated;
(c) the potential accidents that could occur by brushing against a device that protrudes from a lock is non existent;
(d) questions of why something is hanging out of a lock is eliminated;
(e) our invention cannot be forced from the lock because there is nothing to take hold of.

### DRAWINGS

FIG. 1 shows a safe deposit lock with key inserted in the keyway and also a typical safe deposit key;

FIG. 2 shows a keyway plug;

FIG. 3 shows a keyway plug insertion device;

FIG. 4 shows a keyway plug extractor

FIG. 5 shows an exploded side view of a safe deposit lock;

FIG. 6 shows a side view of the keyway plug and insertion device in a safe deposit lock;

FIG. 7 shows an exploded side view of a safe deposit lock with a keyway plug inserted;

FIG. 8 shows an exploded side view of the keyway plug being removed from a safe deposit lock with the extractor;

FIG. 9 shows a prior art device that can be used to plug a keyway; and

FIG. 10 shows a prior art plug device inserted in a safe deposit lock.

### DRAWINGS

### Reference Numerals

| | | | |
|---|---|---|---|
| 10 | key plug | 12 | head of extractor |
| 14 | insertion device | 16 | keyway |
| 18 | extractor | 20 | safe deposit lock |
| 22 | customer post | 24 | cover |
| 26a-26g | wafer tumblers | 28 | locking bolt |

### DETAILED DESCRIPTION OF THE DRAWINGS

The keyway plug 10, of the present invention provides a means of preventing the correct key from opening a safe deposit lock. The figures of the present disclosure show the present invention in operation with a safe deposit lock.

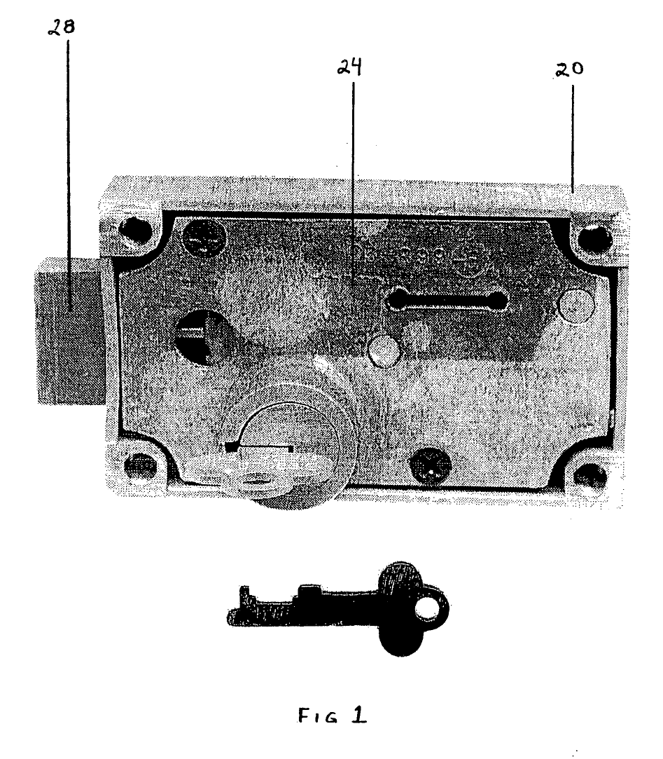

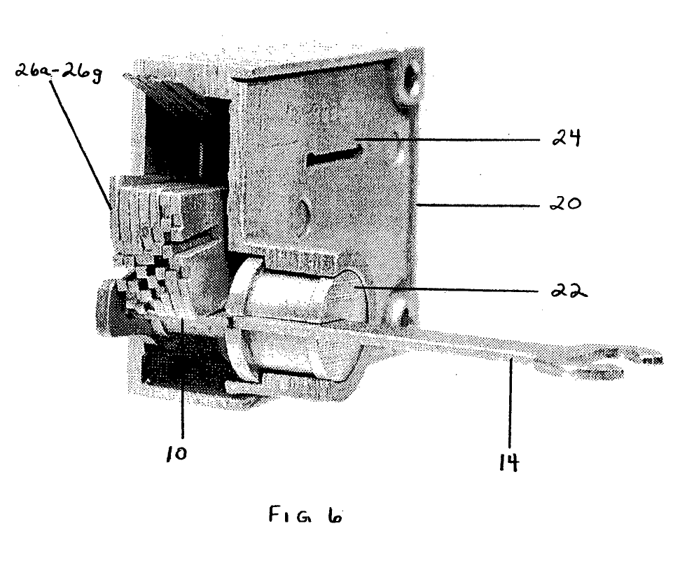

FIG. 1 illustrates a typical self serve safe deposit lock 20 with which the present invention will be used. The lock 20 includes a customer post 22 that rotates within the lock cover 24, a keyway 16, a series of wafer tumblers 26a-26g shown in FIG. 5 and a locking bolt 28. When the correct key (not shown) is inserted into the keyway 16, the wafer tumblers 26a-26g are aligned, permitting the customer post 22 to rotate and retract the locking bolt 28.

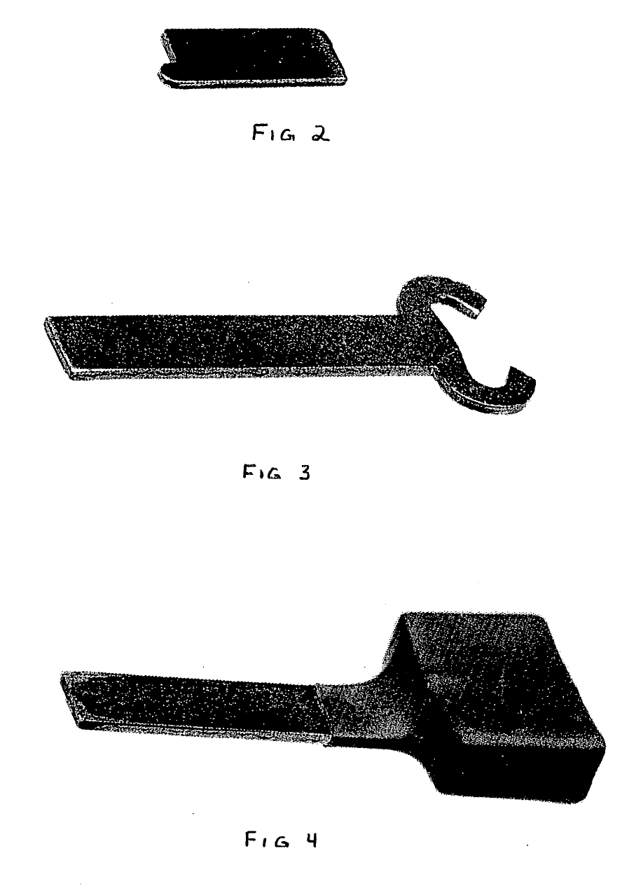

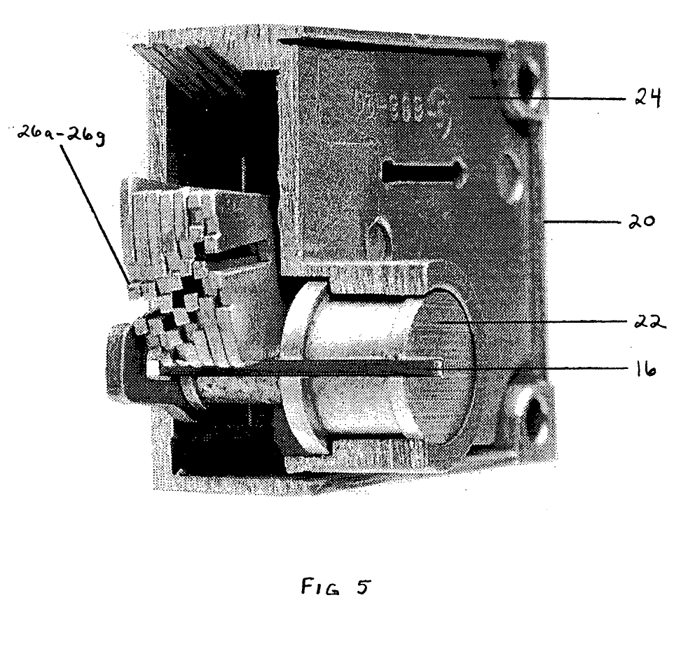

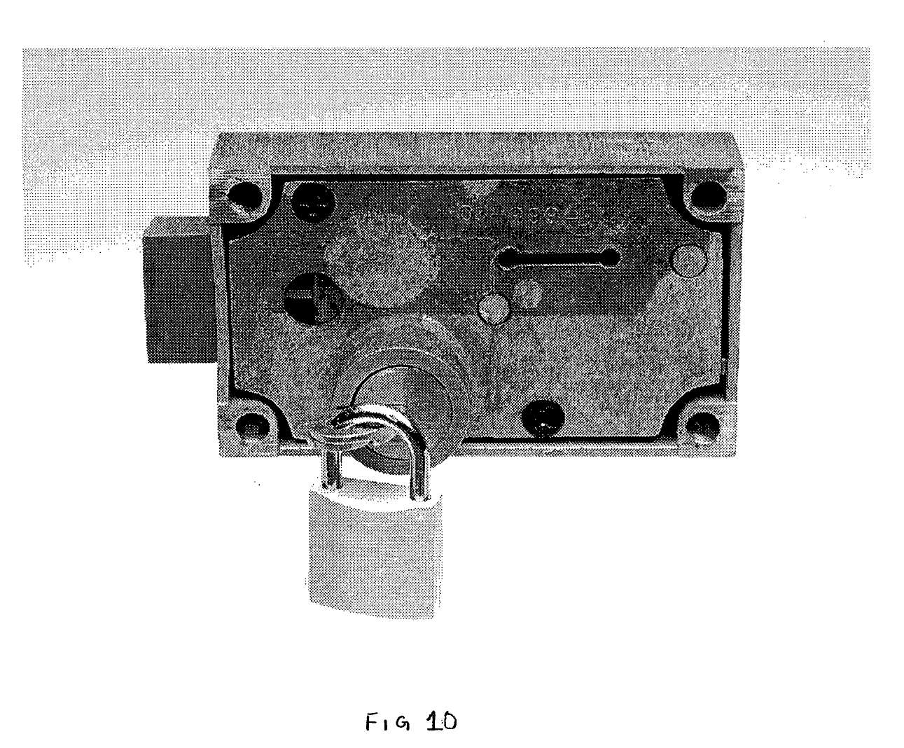

The keyway plug 10 of the present invention has at least two components, a plug 10 (FIG. 2) and an extractor 18 (FIG. 3). The purpose of the plug 10 is to prevent the key from completely being inserted into the keyway 16. The side view of the lock 20 and the plug 10 is shown in FIG. 7. The plug 10 is seated at the back of the keyway 16. Unlike the plug of the prior art FIG. 9 which we are aware of but could find no issued patent. Our plug 10 is hidden from casual inspection and does not protrude out of the keyway 16 like that of the prior art shown in FIG. 10.

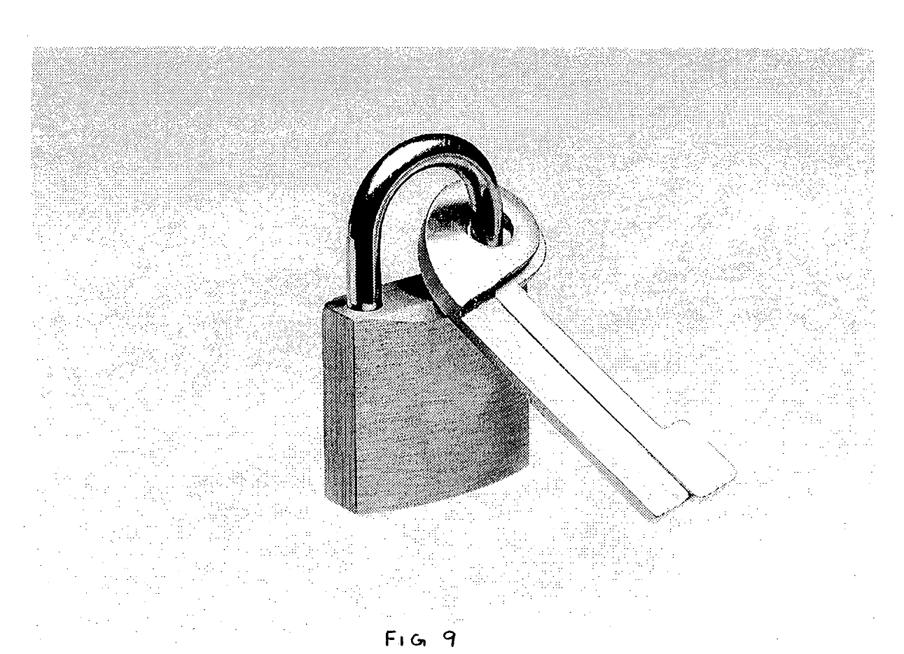

The plug 10 is removed from the keyway 16 by an extractor 18 shown in FIG. 4 and illustrated in FIG. 8. The extractor 18 includes a magnet that is mounted inside of the head 12 which is used for grasping, like that of a regular key. When the extractor 18 is inserted into the keyway 16 and makes contact with the plug 10 it magnetizes the plug 10. The plug 10 being magnetized will follow the extractor 18 as it is pulled from the keyway 16.

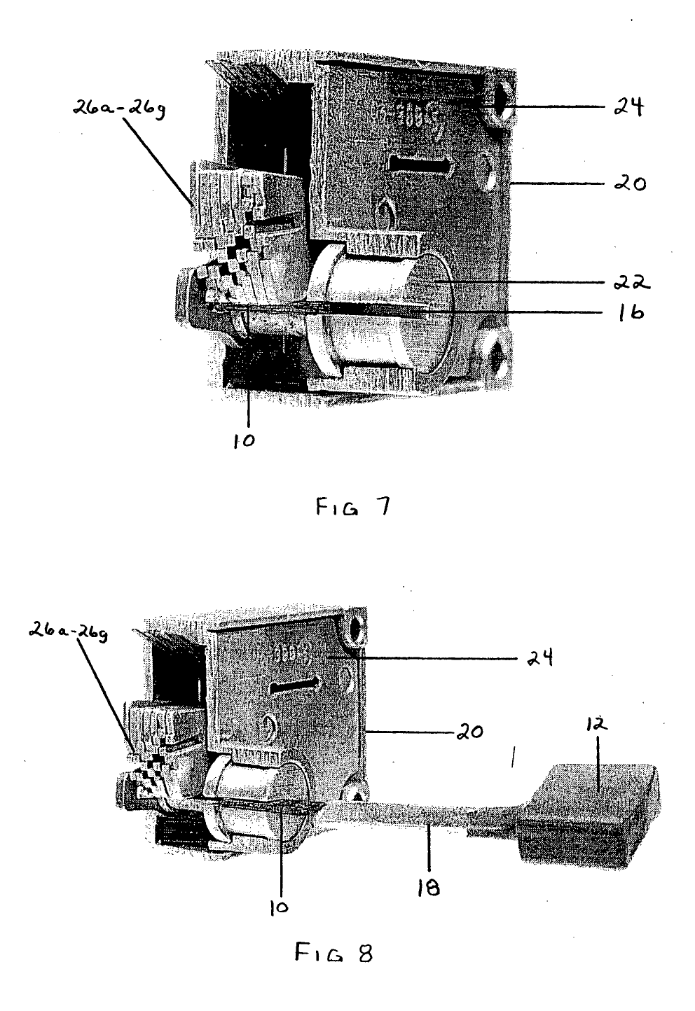

The plug 10 is inserted into the keyway 16 by placing it in the entrance to the keyway 16 and pushing it into the keyway 16 until it stops. The plug 10 is initially placed and started into the keyway 16 manually. Once the plug 10 is inserted a small distance, to the point where a person's finger cannot push it in farther, a tool, such as a regular key FIG. 1 or a blank, must be used to push it in the rest of the way. Optionally, an inserter 14 shown in Fig: 3 and illustrated in FIG. 6, is provided with the plug-10 and the extractor 18. Preferably, the inserter 14 is similar to the extractor 18 with the exception of the magnet that is concealed in the head 12. The inserter 14 is removed from the keyway 16 after the plug 10 is fully inserted. Because the inserter 14 does not have a magnet attached, the plug 10 remains in the keyway 16.

Thus it has been shown and described a keyway plug which satisfies the objects set forth above.

1. A keyway plug for use with a safe deposit lock having a keyway with an entrance into which a key is inserted and a plurality of tumblers, said plurality of tumblers including an outermost tumbler adjacent to said entrance, innermost tumblers away from said entrance, and central tumblers there between, said keyway plug comprising:
(a) a steel plug having a tip and approximate size of said keyway
(b) said plug adapted to fit into said keyway such that said plug occupies latter part of keyway, thus preventing easy removal of said plug;
(c) an insertion device to push the said plug to the back of the said keyway ensuring proper depth of said plug;
(d) a steel extractor including a magnet;
(e) whereby, when said extractor is inserted into said keyway and contact is made with said plug the said plug can be removed by pulling the said extractor.
